(19) United States
(12) Patent Application Publication
(10) Pub. No.: US 2024/0402404 A1
(43) Pub. Date: Dec. 5, 2024

(54) INFRARED FILTER FILM LAYER AND INFRARED FILTER STRUCTURE

(71) Applicant: TAIWAN COLOR OPTICS, INC., Taichung City (TW)

(72) Inventors: CHIH-FENG WANG, Taichung City (TW); KUO-YIN HUANG, Taichung City (TW); WEN-YU WANG, Taichung City (TW); Ke-Peng Chang, Taichung City (TW); YUNG-PENG CHANG, Taichung City (TW); Cheng-Wei Chu, Taichung City (TW)

(21) Appl. No.: 18/676,453

(22) Filed: May 28, 2024

(30) Foreign Application Priority Data
May 31, 2023 (TW) 112120229

(51) Int. Cl. G02B 5/20

(52) U.S. Cl. CPC G02B 5/208

(57) ABSTRACT

An infrared filter film layer and an infrared filter structure are provided. The infrared filter film layer includes at least one silicon-based layer, at least one isolation layer, and at least one oxide layer that are stacked with each other. The at least one isolation layer is disposed between the at least one silicon-based layer and the at least one oxide layer. Through this configuration, the infrared filter film layer has good quality, such that an amount of wavelength drift is small in application. The infrared filter structure includes a light-transmitting substrate and the infrared filter film layer.

### CROSS-REFERENCE TO RELATED PATENT APPLICATION

This application claims the benefit of priority to Taiwan Patent Application No. 112120229, filed on May 31, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an infrared filter film layer, and more particularly to an infrared filter film layer and an infrared filter structure of an interference filter.

### BACKGROUND OF THE DISCLOSURE

Optical coating is widely used in everyday life, and can be used for light shielding, light filtering, waterproofing, or even appearance design. Generally, most optical coating structures are multi-layer interference optical films, and are usually made of two or more materials. In the design of a filter of an infrared band (such as long-pass filters, short-pass filters, or band-pass filters), since the band used is the infrared band, multiple and thick film layers are usually needed for suppression of a visible light band. As a result, the manufacturing costs are increased. The multi-layer interference optical films are usually formed by stacking oxides having high and low refractive indexes on top of each other, such as using tantalum pentoxide, titanium dioxide, or niobium pentoxide in cooperation with silicon dioxide. However, this design requires great thickness to achieve blocking of the visible light band, so that the manufacturing costs of the coating are high. In addition, in the conventional technology, the multi-layer interference optical films can also be formed by alternate stacking of hydrides and oxides, such as silicon hydride and silicon dioxide. Since the use of hydrogen gas is limited in the manufacturing process, production can be inconvenient.

Regarding optical filters, an oxide layer is usually coated on a silicon layer to effectively reduce the film thickness. However, oxygen atoms in the oxide layer are easily combined with the silicon in the silicon layer, so that the quality of the produced optical film is unstable, and the problem of wavelength drift is likely to occur during use. Therefore, how to improve the quality of an infrared filter film and reduce the problem of wavelength drift through improvements in structural design has become one of the important issues to be solved in the relevant industry.

### SUMMARY OF THE DISCLOSURE

In response to the above-referenced technical inadequacies, the present disclosure provides an infrared filter film layer and an infrared filter structure.

In order to solve the above-mentioned problems, one of the technical aspects adopted by the present disclosure is to provide an infrared filter film layer. The infrared filter film layer includes at least one silicon-based layer, at least one isolation layer, and at least one oxide layer that are stacked with each other. The at least one isolation layer is disposed between the at least one silicon-based layer and the at least one oxide layer.

In one of the possible or preferred embodiments, the at least one isolation layer is a nitride film.

In one of the possible or preferred embodiments, a material of the nitride film is selected from the group consisting of silicon nitride (Si₃N₄), aluminum nitride (AlN), niobium nitride (NbN), tantalum nitride (TaN) and zirconium nitride (ZrN).

In one of the possible or preferred embodiments, a thickness of the at least one isolation layer is from 6 nm to 150 nm.

In one of the possible or preferred embodiments, the at least one oxide layer is a silicon dioxide layer (SiO2).

In one of the possible or preferred embodiments, a bottom layer of the infrared filter film layer defines a bonding layer, and the bonding layer is the at least one silicon-based layer, the at least one isolation layer, or the at least one oxide layer.

In order to solve the above-mentioned problems, another one of the technical aspects adopted by the present disclosure is to provide an infrared filter structure. The infrared filter structure includes a light-transmitting substrate and the above-mentioned infrared filter film layer. The infrared filter film layer is coated on a first surface of the light-transmitting substrate.

In one of the possible or preferred embodiments, the infrared filter structure further includes another infrared filter film layer coated on a second surface of the light-transmitting substrate. The second surface is opposite to the first surface.

In one of the possible or preferred embodiments, the light-transmitting substrate is made of a glass substrate, a sapphire substrate, or a resin substrate.

Therefore, in the infrared filter film layer and the infrared filter structure provided by the present disclosure, by virtue of “the at least one isolation layer being disposed between the at least one silicon-based layer and the at least one oxide layer,” oxygen atoms of the oxide layer can be prevented from diffusing into the silicon-based layer, so as to improve the stability of the infrared filter film layer. In addition, by virtue of “the at least one isolation layer being a nitride film,” the quality of the infrared filter film layer can be improved, such that an amount of wavelength drift can be reduced in application.

Furthermore, the infrared filter film layer and the infrared filter structure provided by the present disclosure can be used in an infrared light detection and ranging (lidar) device to improve the impact caused by various environment changes, thereby enhancing the accuracy of lidar detection.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a structure of an infrared filter film layer according to a first embodiment of the present disclosure;

FIG. 2 is a schematic diagram of a structure of an infrared filter film layer according to a second embodiment of the present disclosure;

FIG. 3 is a schematic diagram of a structure of an infrared filter film layer according to a third embodiment of the present disclosure;

FIG. 4 is a spectrum simulation diagram of an infrared filter film layer being applied to an anti-reflection film according to one embodiment of the present disclosure;

FIG. 5 is a spectrum simulation diagram of an infrared filter film layer being applied to a long-pass filter according to one embodiment of the present disclosure;

FIG. 6 is a spectrum simulation diagram of an infrared filter film layer being applied to a short-pass filter according to one embodiment of the present disclosure;

FIG. 7 is a spectrum simulation diagram of an infrared filter film layer being applied to a band-pass filter according to one embodiment of the present disclosure;

FIG. 8 is a schematic diagram of an infrared filter structure according to the first embodiment of the present disclosure;

FIG. 9 is a schematic diagram of an infrared filter structure according to the second embodiment of the present disclosure; and

FIG. 10 is a schematic diagram of an infrared filter structure according to the third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

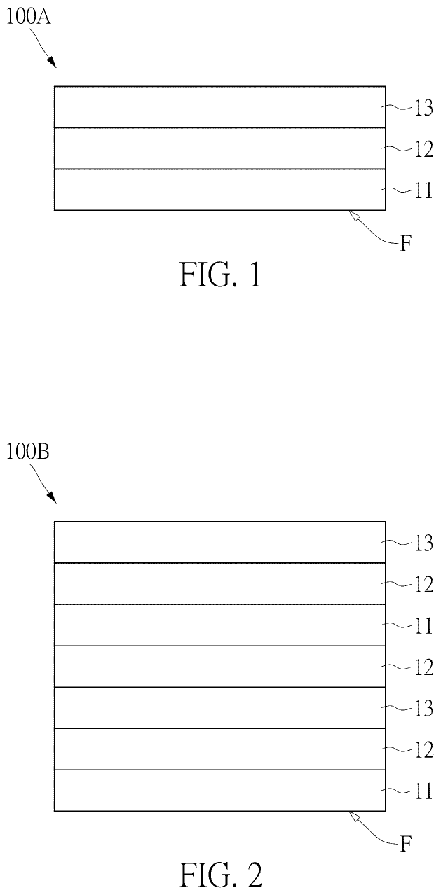

Referring to FIG. 1, FIG. 1 is a schematic diagram of a structure of an infrared filter film layer 100A according to a first embodiment of the present disclosure. The infrared filter film layer 100A includes a silicon-based layer 11, an isolation layer 12, and an oxide layer 13. The isolation layer 12 is located between the silicon-based layer 11 and the oxide layer 13. In some embodiments, a quantity of each of the silicon-based layer 11, the isolation layer 12, and the oxide layer 13 is at least one, and the isolation layer 12 is disposed between the silicon-based layer 11 and the oxide layer 13 (details thereof will be illustrated below).

In the embodiment shown in FIG. 1, the silicon-based layer 11 is a bonding layer, and a bottom surface of the bonding layer defines a bonding surface F. The bonding surface F can be coated, adhered, or attached to a surface of a target object. For example, the target object can be a glass substrate or a resin substrate (e.g., a polycarbonate (PC) resin). According to some embodiments, a bottom layer of an infrared filter film layer is the oxide layer 13 (i.e., the bonding layer), and a surface of the oxide layer 13 defines the bonding surface F. According to some embodiments, the bottom layer of the infrared filter film layer is the isolation layer 12 (i.e., the bonding layer), and a surface of the isolation layer 12 defines the bonding surface F.

A main material of the silicon-based layer 11 is silicon (Si). According to some embodiments, the oxide layer 13 can be a silicon dioxide layer (SiO2), but is not limited thereto. The isolation layer 12 is used to isolate the silicon-based layer 11 and the oxide layer 13, so as to prevent oxygen atoms of the oxide layer 13 from diffusing into the silicon-based layer 11. The isolation layer 12 is made of a material having good adhesion to the silicon-based layer 11 and the oxide layer 13. According to some embodiments, the isolation layer 12 is a nitride film. For example, a material of the nitride film is at least one selected from the group consisting of silicon nitride (Si₃N₄), aluminum nitride (AlN), niobium nitride (NbN), tantalum nitride (TaN) and zirconium nitride (ZrN). According to some embodiments, a thickness of the isolation layer 12 is from 6 nm to 150 nm.

Referring to FIG. 2, FIG. 2 is a schematic diagram of a structure of an infrared filter film layer 100B according to a second embodiment of the present disclosure. In this embodiment, the infrared filter film layer 100B includes two silicon-based layers 11, two oxide layers 13, and three isolation layers 12. Each of the three isolation layers 12 is disposed between a corresponding one of the silicon-based layers 11 and a corresponding one of the oxide layers 13 that are adjacent to each other. The present disclosure does not limit the quantity of the silicon-based layer 11, the isolation layer 12, and the oxide layer 13. However, in order to improve the situation in which the oxygen atoms of the oxide layer 13 diffuse into the silicon-based layer 11, the isolation layer 12 is provided between the silicon-based layer 11 and the oxide layer 13. In this embodiment, from bottom to top, the silicon-based layer 11, the isolation layer 12, the oxide layer 13, the isolation layer 12, the silicon-based layer 11, the isolation layer 12, and the oxide layer 13 are sequentially stacked to form the infrared filter film layer 100B. In addition, the overall thickness of the infrared filter film layer is not limited in the present disclosure, which can be adjusted according to the requirements of a user or a manufacturer. For example, the entire infrared filter film layer can be formed by stacking multiple ones of the infrared filter film layer 100A shown in FIG. 1, in which the isolation layer 12 is provided between the silicon-based layer 11 and the oxide layer 13.

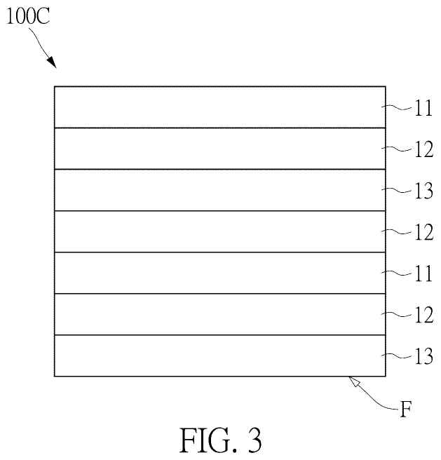

Referring to FIG. 3, FIG. 3 is a schematic diagram of a structure of an infrared filter film layer 100C according to a third embodiment of the present disclosure. In this embodiment, the infrared filter film layer 100C includes two silicon-based layers 11, two oxide layers 13, and three isolation layers 12. Different from the second embodiment, the bonding surface F of the infrared filter film layer 100C in the third embodiment is the surface of the oxide layer 13. The stack structure of the infrared filter film layer 100C sequentially includes, from bottom to top, the oxide layer 13, the isolation layer 12, the silicon-based layer 11, the isolation layer 12, the oxide layer 13, the isolation layer 12, and the silicon-based layer 11. According to some embodiments, the bonding surface F is the surface of the oxide layer 13. The entire infrared filter film layer is formed by stacking the multiple oxide layers 13, the multiple isolation layers 12, and the multiple silicon-based layers 11, and each of the multiple isolation layers 12 is disposed between a corresponding one of the oxide layers 13 and a corresponding one of the silicon-based layers 11 that are adjacent to each other.

According to some embodiments, the isolation layer 12 is used as the bonding layer, and its surface is the bonding surface F. The bonding surface F can be coated, adhered, or attached to the surface of the target object. At this time, the infrared filter film layer sequentially includes, from bottom to top, the isolation layer 12, the silicon-based layer 11, the isolation layer 12, the oxide layer 13, the isolation layer 12, and the silicon-based layer 11 (in an example where there are three isolation layers 12, two silicon-based layers 11, and one oxide layer 13). Regardless of how many layers there are in the entire infrared filter film layer, the isolation layer 12 is provided between the silicon-based layer 11 and the oxide layer 13.

According to some embodiments, the isolation layer 12 is used as the bonding layer, and its surface is used as the bonding surface F. The bonding surface F can be coated, adhered, or attached to the surface of the target object. Different from the aforementioned embodiments, it is the oxide layer 13 that is disposed adjacent to the isolation layer 12. In an example where there are three isolation layers 12, two oxide layers 13, and one silicon-based layer 11, the infrared filter film layer sequentially includes, from bottom to top, the isolation layer 12, the oxide layer 13, the isolation layer 12, the silicon-based layer 11, the isolation layer 12, and the oxide layer 13. Regardless of how many layers there are in the entire infrared filter film layer, the isolation layer 12 is provided between the oxide layer 13 and the silicon-based layer 11.

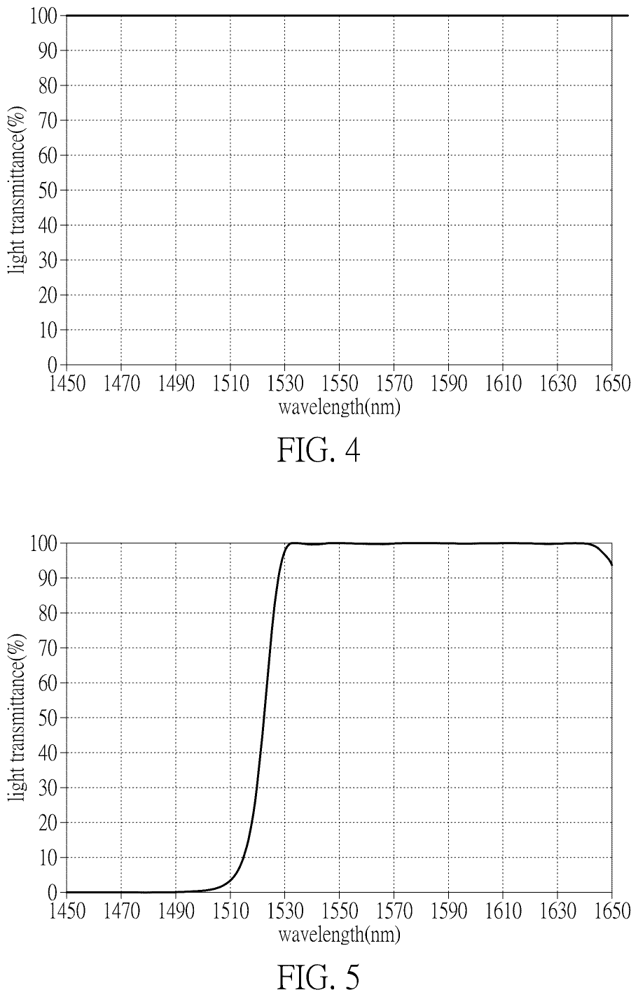

Reference is made to FIG. 4, which is a spectrum simulation diagram of an infrared filter film layer being applied to an anti-reflection (AR) film according to one embodiment of the present disclosure. The composition of the infrared filter film layer is shown in Table 1.

TABLE 1

| | | Film |
|---|---|---|
| | | thickness |
| Order of layers | Material | (nm) |
| 1 | Si₃N₄ | 7.1 |
| 2 | Si | 20.36 |
| 3 | Si₃N₄ | 10.46 |
| 4 | SiO₂ | 88.67 |
| 5 | Si₃N₄ | 7.99 |
| 6 | Si | 158.46 |
| 7 | Si₃N₄ | 6.59 |
| 8 | SiO₂ | 8 |
| 9 | Si₃N₄ | 7.74 |
| 10 | Si | 59.26 |
| 11 | Si₃N₄ | 6.03 |
| 12 | SiO₂ | 269.54 |

In this embodiment, the total number of layers is 12, and the isolation layer 12 is the bottom layer. As shown in FIG. 4, for light waves having wavelengths of from 1,450 nm to 1,650 nm, the light transmittance is more than 99%.

Reference is made to FIG. 5, which is a spectrum simulation diagram of an infrared filter film layer being applied to a long-pass (LP) filter according to one embodiment of the present disclosure. The composition of the infrared filter film layer is shown in Table 2.

TABLE 2

| Order | | Film |
|---|---|---|
| of | | thickness |
| layers | Material | (nm) |
| 1 | Si₃N₄ | 29.36 |
| 2 | Si | 53.34 |
| 3 | Si₃N₄ | 43.9 |
| 4 | SiO₂ | 114.72 |
| 5 | Si₃N₄ | 8.07 |
| 6 | Si | 106.68 |
| 7 | Si₃N₄ | 8 |
| 8 | SiO₂ | 59.89 |
| 9 | Si₃N₄ | 8 |
| 10 | Si | 106.68 |
| 11 | Si₃N₄ | 10.39 |
| 12 | SiO₂ | 175.45 |
| 13 | Si₃N₄ | 8.48 |
| 14 | Si | 106.68 |
| 15 | Si₃N₄ | 8 |
| 16 | SiO₂ | 158.59 |
| 17 | Si₃N₄ | 14.4 |
| 18 | Si | 106.68 |
| 19 | Si₃N₄ | 12.38 |
| 20 | SiO₂ | 73.26 |
| 21 | Si₃N₄ | 8 |
| 22 | Si | 106.68 |
| 23 | Si₃N₄ | 55.31 |
| 24 | SiO₂ | 8 |
| 25 | Si₃N₄ | 54.3 |
| 26 | Si | 106.68 |
| 27 | Si₃N₄ | 13.91 |
| 28 | SiO₂ | 181.59 |
| 29 | Si₃N₄ | 8.03 |
| 30 | Si | 106.68 |
| 31 | Si₃N₄ | 8 |
| 32 | SiO₂ | 162.33 |
| 33 | Si₃N₄ | 23.67 |
| 34 | Si | 106.68 |
| 35 | Si₃N₄ | 36.74 |
| 36 | SiO₂ | 8 |
| 37 | Si₃N₄ | 38.21 |
| 38 | Si | 106.68 |
| 39 | Si₃N₄ | 21.46 |
| 40 | SiO₂ | 106.78 |
| 41 | Si₃N₄ | 8.05 |
| 42 | Si | 106.68 |
| 43 | Si₃N₄ | 12.34 |
| 44 | SiO₂ | 159.25 |
| 45 | Si₃N₄ | 8.06 |
| 46 | Si | 106.68 |
| 47 | Si₃N₄ | 8.06 |
| 48 | SiO₂ | 149.11 |
| 49 | Si₃N₄ | 17.73 |
| 50 | Si | 106.68 |
| 51 | Si₃N₄ | 43.45 |
| 52 | SiO₂ | 8 |
| 53 | Si₃N₄ | 43.96 |
| 54 | Si | 106.68 |
| 55 | Si₃N₄ | 14.63 |
| 56 | SiO₂ | 122.05 |
| 57 | Si₃N₄ | 8.78 |
| 58 | Si | 106.68 |
| 59 | Si₃N₄ | 60 |
| 60 | SiO₂ | 8 |
| 61 | Si₃N₄ | 57.99 |
| 62 | Si | 106.68 |
| 63 | Si₃N₄ | 9.18 |
| 64 | SiO₂ | 179.38 |
| 65 | Si₃N₄ | 9.33 |
| 66 | Si | 106.68 |
| 67 | Si₃N₄ | 50.21 |
| 68 | SiO₂ | 8 |
| 69 | Si₃N₄ | 43.51 |
| 70 | Si | 106.68 |
| 71 | Si₃N₄ | 8.1 |
| 72 | SiO₂ | 78.13 |
| 73 | Si₃N₄ | 54.53 |
| 74 | Si | 53.34 |
| 75 | Si₃N₄ | 8 |

In this embodiment, there are 75 layers in total, and the isolation layer 12 acts as the bottom layer. As shown in FIG. 5, for light waves having wavelengths of from 1,530 nm to 1,650 nm, the light transmittance is from 95% to 100%.

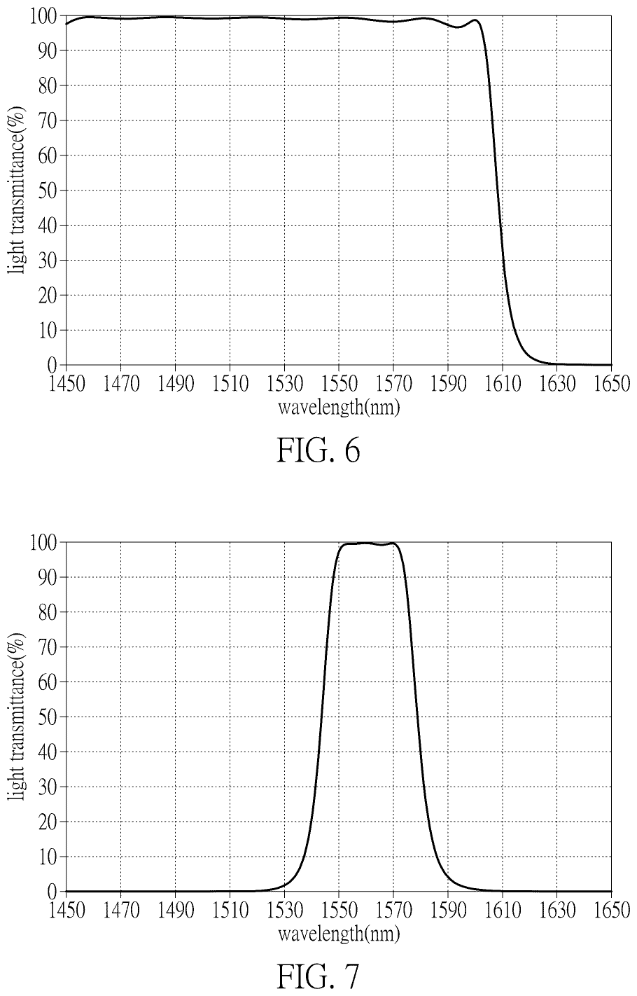

Reference is made to FIG. 6, which is a spectrum simulation diagram of an infrared filter film layer being applied to a short-pass (SP) filter according to one embodiment of the present disclosure. The composition of the infrared filter film layer is shown in Table 3.

TABLE 3

| Order | | Film |
|---|---|---|
| of | | thickness |
| layers | Material | (nm) |
| 1 | Si₃N₄ | 8 |
| 2 | Si | 184.93 |
| 3 | Si₃N₄ | 14.17 |
| 4 | SiO₂ | 8 |
| 5 | Si₃N₄ | 18.65 |
| 6 | SiO₂ | 266.48 |
| 7 | Si₃N₄ | 8.12 |
| 8 | Si | 184.93 |
| 9 | Si₃N₄ | 8.03 |
| 10 | SiO₂ | 222.84 |
| 11 | Si₃N₄ | 8.01 |
| 12 | Si | 184.93 |
| 13 | Si₃N₄ | 8 |
| 14 | SiO₂ | 208.06 |
| 15 | Si₃N₄ | 19.4 |
| 16 | Si | 184.93 |
| 17 | Si₃N₄ | 23.88 |
| 18 | SiO₂ | 205.66 |
| 19 | Si₃N₄ | 8 |
| 20 | Si | 184.93 |
| 21 | Si₃N₄ | 8 |
| 22 | SiO₂ | 215.49 |
| 23 | Si₃N₄ | 8 |
| 24 | Si | 184.93 |
| 25 | Si₃N₄ | 8 |
| 26 | SiO₂ | 204.55 |
| 27 | Si₃N₄ | 18.48 |
| 28 | Si | 184.93 |
| 29 | Si₃N₄ | 19.52 |
| 30 | SiO₂ | 200.51 |
| 31 | Si₃N₄ | 13.51 |
| 32 | Si | 184.93 |
| 33 | Si₃N₄ | 8 |
| 34 | SiO₂ | 212.05 |
| 35 | Si₃N₄ | 8 |
| 36 | Si | 184.93 |
| 37 | Si₃N₄ | 8 |
| 38 | SiO₂ | 202.05 |
| 39 | Si₃N₄ | 16.16 |
| 40 | Si | 184.93 |
| 41 | Si₃N₄ | 21.38 |
| 42 | SiO₂ | 212.31 |
| 43 | Si₃N₄ | 8 |
| 44 | Si | 184.93 |
| 45 | Si₃N₄ | 8 |
| 46 | SiO₂ | 210.61 |
| 47 | Si₃N₄ | 8 |
| 48 | Si | 184.93 |
| 49 | Si₃N₄ | 26.57 |
| 50 | SiO₂ | 155.36 |
| 51 | Si₃N₄ | 34.27 |
| 52 | Si | 184.93 |
| 53 | Si₃N₄ | 8 |
| 54 | SiO₂ | 211.85 |
| 55 | Si₃N₄ | 16.47 |
| 56 | Si | 184.93 |
| 57 | Si₃N₄ | 28.45 |
| 58 | SiO₂ | 199.99 |
| 59 | Si₃N₄ | 8 |
| 60 | Si | 184.93 |
| 61 | Si₃N₄ | 10.56 |
| 62 | SiO₂ | 195.78 |
| 63 | Si₃N₄ | 45.94 |
| 64 | Si | 184.93 |
| 65 | Si₃N₄ | 48.61 |

In this embodiment, there are 65 layers in total, and the isolation layer 12 acts as the bottom layer. As shown in FIG. 6, for light waves having wavelengths of from 1,450 nm to 1,600 nm, the light transmittance is from 95% to 100%.

Reference is made to FIG. 7, which is a spectrum simulation diagram of an infrared filter film layer being applied to a band-pass (BP) filter according to one embodiment of the present disclosure. The composition of the infrared filter film layer is shown in Table 4.

TABLE 4

| Order | | Film |
|---|---|---|
| of | | thickness |
| layers | Material | (nm) |
| 1 | SiO₂ | 8.08 |
| 2 | Si₃N₄ | 8.76 |
| 3 | Si | 91.27 |
| 4 | Si₃N₄ | 20.34 |
| 5 | SiO₂ | 39.17 |
| 6 | Si₃N₄ | 13.58 |
| 7 | Si | 112.31 |
| 8 | Si₃N₄ | 40.76 |
| 9 | SiO₂ | 194.13 |
| 10 | Si₃N₄ | 28.03 |
| 11 | Si | 45.65 |
| 12 | Si₃N₄ | 6.03 |
| 13 | Si | 156.26 |
| 14 | Si₃N₄ | 45.52 |
| 15 | SiO₂ | 32.51 |
| 16 | Si₃N₄ | 50.26 |
| 17 | Si | 245.82 |
| 18 | Si₃N₄ | 50.26 |
| 19 | SiO₂ | 8.04 |
| 20 | Si₃N₄ | 44.78 |
| 21 | Si | 143.29 |
| 22 | Si₃N₄ | 25.94 |
| 23 | SiO₂ | 195.23 |
| 24 | Si₃N₄ | 14.71 |
| 25 | Si | 106.6 |
| 26 | Si₃N₄ | 14.02 |
| 27 | SiO₂ | 195.15 |
| 28 | Si₃N₄ | 25.84 |
| 29 | Si | 118.23 |
| 30 | Si₃N₄ | 50.26 |
| 31 | SiO₂ | 132.44 |
| 32 | Si₃N₄ | 50.26 |
| 33 | Si | 185.42 |
| 34 | Si₃N₄ | 6.03 |
| 35 | Si | 54.7 |
| 36 | Si₃N₄ | 50.26 |
| 37 | SiO₂ | 8.04 |
| 38 | Si₃N₄ | 50.26 |
| 39 | Si | 185.23 |
| 40 | Si₃N₄ | 50.26 |
| 41 | SiO₂ | 8.04 |
| 42 | Si₃N₄ | 50.26 |
| 43 | Si | 131.23 |
| 44 | Si₃N₄ | 24.85 |
| 45 | SiO₂ | 183.94 |
| 46 | Si₃N₄ | 17.69 |
| 47 | Si | 104.19 |
| 48 | Si₃N₄ | 40.08 |
| 49 | SiO₂ | 159.59 |
| 50 | Si₃N₄ | 39.99 |
| 51 | Si | 154.88 |
| 52 | Si₃N₄ | 50.26 |
| 53 | SiO₂ | 48.33 |
| 54 | Si₃N₄ | 50.26 |
| 55 | Si | 130.68 |
| 56 | Si₃N₄ | 6.03 |
| 57 | Si | 110.43 |
| 58 | Si₃N₄ | 50.26 |
| 59 | SiO₂ | 61.86 |
| 60 | Si₃N₄ | 50.26 |
| 61 | Si | 179.62 |
| 62 | Si₃N₄ | 49.66 |
| 63 | SiO₂ | 8.04 |
| 64 | Si₃N₄ | 50.26 |
| 65 | Si | 72.91 |
| 66 | Si₃N₄ | 6.12 |
| 67 | SiO₂ | 8.04 |
| 68 | Si₃N₄ | 6.08 |

In this embodiment, there are 68 layers in total, and the oxide layer 13 acts as the bottom layer. As shown in FIG. 7, for light waves having wavelengths of from 1,550 nm to 1,580 nm, the light transmittance is more than 99%.

Reference is made to FIG. 8, which is a schematic diagram of an infrared filter structure 200A according to the first embodiment of the present disclosure. In this embodiment, the infrared filter structure 200A includes a light-transmitting substrate 2 and an infrared filter film layer. The infrared filter film layer includes a plurality of silicon-based layers 11, a plurality of isolation layers 12, and a plurality of oxide layers 13. The infrared filter film layer uses the silicon-based layer 11 as a bonding layer (hereinafter referred to as a first aspect), which is disposed on a first surface 21 of the light-transmitting substrate 2. The infrared filter film layer is disposed on the light-transmitting substrate 2 by the coating technology, and the present disclosure does not limit a coating method for producing an infrared filter structure. The light-transmitting substrate 2 is made of, for example, a glass substrate. In some embodiments, the light-transmitting substrate 2 is made of a resin substrate. In addition, in some embodiments, the light-transmitting substrate 2 is made of a sapphire substrate.

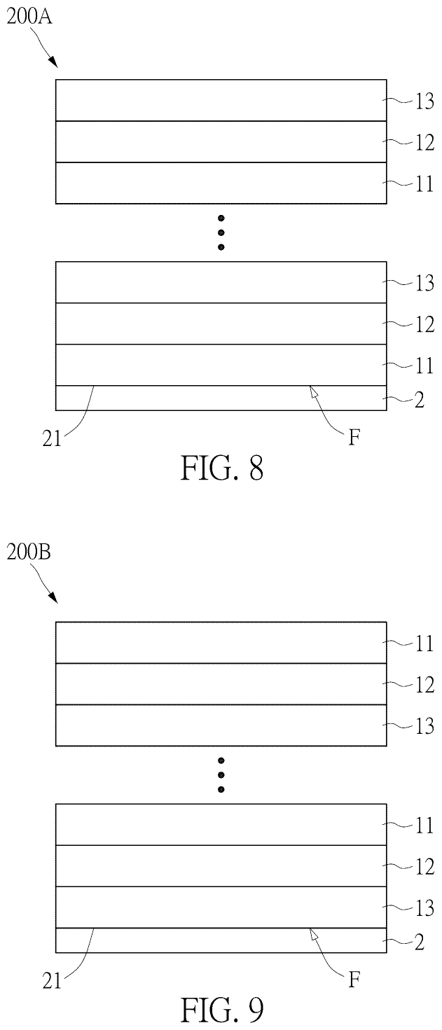

Reference is made to FIG. 9, which is a schematic diagram of an infrared filter structure 200B according to the second embodiment of the present disclosure. In this embodiment, the infrared filter film layer includes the plurality of silicon-based layers 11, the plurality of isolation layers 12, and the plurality of oxide layers 13. The infrared filter layer uses the oxide layer 13 as the bonding layer (hereinafter referred to as a second aspect), which is disposed on the first surface 21 of the light-transmitting substrate 2.

According to some embodiments, in the infrared filter structure, the infrared filter film layer uses the isolation layer 12 as the bonding layer. In this case, the silicon-based layer 11 can be disposed on the isolation layer 12 (hereinafter referred to as a third aspect), or the oxide layer 13 can be disposed on the isolation layer 12 (hereinafter referred to as a fourth aspect).

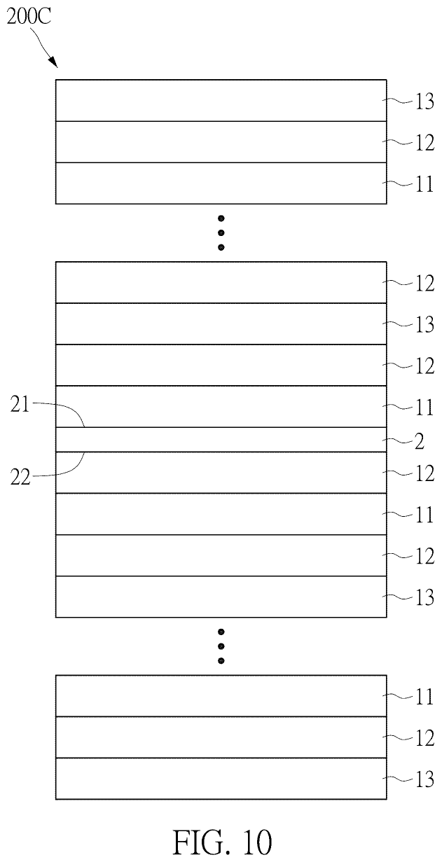

Reference is made to FIG. 10, which is a schematic diagram of an infrared filter structure 200C according to the third embodiment of the present disclosure. In this embodiment, the infrared filter structure 200C also includes another infrared filter film layer coated on a second surface 22 of the light-transmitting substrate 2. The infrared filter film layer on the first surface 21 of the light-transmitting substrate 2 can be any one of the first to fourth aspects mentioned above. The infrared filter film layer on the second surface 22 of the light-transmitting substrate 2 can also be any one of the first to fourth aspects mentioned above. Therefore, the infrared filter structure has 16 combinations, which are designed according to the requirements of the user. The present disclosure has no limitation in this regard. According to the embodiment shown in FIG. 10, the infrared filter film layer of the first aspect is disposed on the first surface 21 of the light-transmitting substrate 2, and the infrared filter film layer of the third aspect is disposed on the second surface 22 of the light-transmitting substrate 2.

### Beneficial Effects of the Embodiments

In conclusion, in the infrared filter film layer and the infrared filter structure provided by the present disclosure, by virtue of “the at least one isolation layer being disposed between the at least one silicon-based layer and the at least one oxide layer,” the oxygen atoms of the oxide layer can be prevented from entering the silicon-based layer, so as to improve the stability of the infrared filter film layer and the stability and the reliability of the infrared filter film layer when being used in an infrared region. Furthermore, by virtue of “the at least one isolation layer being a nitride film,” the quality of the infrared filter film layer can be improved, such that an amount of wavelength drift can be reduced.

Furthermore, the infrared filter film layer and the infrared filter structure provided by the present disclosure can be used in an infrared lidar device to improve the impact caused by various environment changes, thereby enhancing the accuracy of lidar detection.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An infrared filter film layer, comprising at least one silicon-based layer, at least one isolation layer, and at least one oxide layer that are stacked with each other, wherein the at least one isolation layer is disposed between the at least one silicon-based layer and the at least one oxide layer.

2. The infrared filter film layer according to claim 1, wherein the at least one isolation layer is a nitride film.

3. The infrared filter film layer according to claim 2, wherein a material of the nitride film is selected from the group consisting of silicon nitride (Si₃N₄), aluminum nitride (AlN), niobium nitride (NbN), tantalum nitride (TaN), and zirconium nitride (ZrN).

4. The infrared filter film layer according to claim 1, wherein a thickness of the at least one isolation layer is from 6 nm to 150 nm.

5. The infrared filter film layer according to claim 1, wherein the at least one oxide layer is a silicon dioxide layer (SiO2).

6. The infrared filter film layer according to claim 1, wherein a bottom layer of the infrared filter film layer defines a bonding layer, and the bonding layer is the at least one silicon-based layer, the at least one isolation layer, or the at least one oxide layer.

7. An infrared filter structure, comprising:
a light-transmitting substrate; and
an infrared filter film layer, wherein the infrared filter film layer includes at least one silicon-based layer, at least one isolation layer, and at least one oxide layer that are stacked with each other, and the at least one isolation layer is disposed between the at least one silicon-based layer and the at least one oxide layer;
wherein the infrared filter film layer is coated on a first surface of the light-transmitting substrate.

8. The infrared filter structure according to claim 7, further comprising another infrared filter film layer coated on a second surface of the light-transmitting substrate, wherein the second surface is opposite to the first surface.

9. The infrared filter structure according to claim 7, wherein the light-transmitting substrate is made of a glass substrate, a sapphire substrate, or a resin substrate.
